(19) United States
(12) Patent Application Publication
(10) Pub. No.: US 2014/0050520 A1
(43) Pub. Date: Feb. 20, 2014

(54) SYSTEMS AND METHODS FOR IMPROVING A TORQUE TRANSFER SYSTEM

(71) Applicant: The Southern Company, Atlanta, GA (US)

(72) Inventors: Donald W. Varner, Birmingham, AL (US); David W. Dodson, Birmingham, AL (US)

(73) Assignee: The Southern Company, Atlanta, GA (US)

(21) Appl. No.: 13/969,301

(22) Filed: Aug. 16, 2013

Related U.S. Application Data
(60) Provisional application No. 61/683,778, filed on Aug. 16, 2012.

(51) Int. Cl. F16D 1/06

(52) U.S. Cl. CPC F16D 1/06
USPC 403/288; 403/345; 29/407.01

(57) ABSTRACT

An exemplary embodiment of the present invention provides a torque transfer system. The torque transfer system can comprise a shaft coupled to a gearbox, and the gearbox can impart torque to the shaft. The torque transfer system can further comprise an adaptor engaged with the shaft and having a hollow center. An output table can also be engaged with the adaptor. A plug can be disposed within the hollow center of the adaptor.

### CROSS-REFERENCE TO RELATED APPLICATIONS

This application claims the benefit of U.S. Provisional Application Ser. No. 61/683,778, filed on 16 Aug. 2013, which is incorporated herein by reference in its entirety as if fully set forth below.

### TECHNICAL FIELD OF THE INVENTION

The various embodiments of the present disclosure relate generally to torque transfer systems. More particularly, the various embodiments of the present invention are directed to systems and methods for improving torque transfer systems in pulverizers.

### BACKGROUND OF THE INVENTION

Pulverizers are machines used to break down, or pulverize, various types of materials. Most commonly, pulverizers are large grinders for breaking down fossil fuels and ore. Many electric power companies and refineries use pulverizers to grind raw coal into small fragments that can be burned to extract energy.

As shown in FIG. 1, pulverizers 100 typically comprise a power input connected to a gearbox 105. The gearbox 105 receives power from the power input, and uses the power to rotate a shaft 110. The shaft 110, in turn, is in rotational communication with an output table 115, enabling the output table 115 to rotate with the shaft 110. Various other components transfer the rotation of the output table 115 to a bowl 120. As the bowl 120 rotates, a journal assembly 125, or other crushing device, breaks down the material.

In many pulverizers, therefore, torque is transferred from the gearbox, through several components, to the bowl. As described above, this process often involves the transfer of torque from a shaft to an output table. To carry out this transfer, many pulverizers employ an adaptor that couples to both the shaft and the output table. The adaptor can be a connector operable to transmit torque and rotation to the output table from the shaft.

Pulverizers should be extremely reliable. Many pulverizers, for example, are designed to operate for several thousand hours without requiring replacement of key components. Despite careful calculations by design engineers, however, the joint between the adaptor and the output table fails prematurely in a notable percentage of pulverizers. This failure can open the joint and enable impurities to enter the pulverizer's oil systems, causing gearbox vibration and/or elevated bearing temperatures. In addition, mechanical failure between the adaptor and the output table can require replacement of the adaptor, output table, and other components damaged by debris. Replacement of these parts can be very expensive, often exceeding $500,000.

To attempt to prevent pulverizer failure, therefore, design engineers calculate the life expectancy of the adaptor, output table, and joint therebetween. By determining life expectancy, the time of failure of the adaptor, output table, and/or joint can be calculated. The adaptor and/or output table can then be replaced before failure, preventing malfunctions during operation. This, in turn, can prevent damage to the pulverizer, and the expensive replacement of additional parts.

Moreover, to determine whether the adaptor, output table, and joint are sufficiently strong to provide a desired life expectancy, engineers determine the factor of safety of the joint, i.e., the material strength of the joint divided by the stress created by the applied load. Generally, a factor of safety of 1.0 or greater provides the strength required to meet or exceed design parameters, such as a desired life expectancy, while a factor of safety below 1.0 indicates that the components are not sufficiently strong.

Although engineers often design the adaptor and output table to last thousands of hours and/or cycles, the joint between the adaptor and output table often fails prematurely, as described above. Although many engineers have examined this problem, a practical solution has evaded discovery.

Therefore, there is a desire for a device that prevents premature failure of the components of a torque transfer system, such as the components of a pulverizer. Various embodiments of the present invention address these desires.

### BRIEF SUMMARY OF THE INVENTION

The present invention relates to systems and methods for improving torque transfer systems. In some embodiments, the present invention relates to systems and methods for improving pulverizers and preventing pulverizer failure. Embodiments of the present invention provide a plug disposed within a hollow center of an adaptor. The plug can form an interference fit with the adaptor, thereby causing the adaptor to expand, and preventing failure of the system.

Embodiments of the present invention can comprise a torque transfer system having a shaft coupled to a gearbox. In some embodiments, the gearbox can be capable of imparting torque to the shaft. An adaptor can be engaged with the shaft, and the adaptor can comprise a hollow center. In some embodiments, an output table can be engaged with an outer surface of the adaptor, and a plug can be disposed within the hollow center of the adaptor. The plug can be sized and shaped to enable the factor of safety of the adaptor and the output table to be greater than or equal to 1.0 during start-up and normal operation of the system.

In some embodiments, the plug and the adaptor form an interference fit. The output table and the adaptor can also form an interference fit. In some embodiments, a plurality of apertures can be disposed between the output table and the adaptor. The apertures can have pins disposed therein, and the pins can be operable to impart torque from the adaptor to the output table.

In some embodiments, the plug substantially prevents debris from entering the hollow center of the adaptor. The plug can comprise a lower corking section and an upper rim section that can be mechanically fastened to the adaptor. Moreover, a gasket can be disposed between the upper rim section and the adaptor. The gasket can be operable to substantially prevent debris from entering the hollow center of the adaptor.

Embodiments of the present invention can further comprise a method of improving a torque transfer system. The torque transfer system can comprise an output table and an adapter engaged with the output table. The adapter can comprise a hollow center and can be operable to transfer torque from a shaft to the output table.

In some embodiments, the present invention can comprise determining a first range of interference fits between the output table and the adaptor. The present invention can additionally comprise determining, based at least in part on the first range of interference fits between the output table and the adaptor, a second range of interference fits between the adaptor and a plug to be installed in the hollow center of the adaptor, such that the factor of safety of the adaptor and the output table is greater than or equal to 1.0 during start-up and normal operation of the pulverizer.

In some embodiments, the present invention comprises installing the plug in the hollow center of the adaptor such that the plug and the adaptor form an interference fit within the second range of interference fits. Installing the plug can comprise cooling the plug and inserting the cooled plug into the hollow center of the adaptor. Moreover, the present invention can comprise installing a pin in an aperture disposed between the output table and the adaptor. The pin can be operable to impart torque from the adaptor to the output table. In some embodiments, installing the plug can comprise installing a gasket between at least a portion of the plug and at least a portion of the adaptor.

In some embodiments, the factor of safety of the output table is less than 1.0 during start-up of the torque transfer system prior to installing the plug. In some embodiments, the factor of safety of the adaptor is less than 1.0 during start-up of the torque transfer system prior to installing the plug.

In some embodiments, at least one of a force applied to the aperture and a force applied to the pin is used to determine the second range of interference fits. Moreover, in some embodiments, determining the second range of interference fits comprises performing finite element analysis. In some embodiments, the present invention comprises substantially preventing debris from entering the hollow center of the adaptor by covering a top opening of the hollow center with the plug.

Embodiments of the present invention can further comprise a system for preventing premature failure of a torque transfer system. The system can comprise an adaptor engaged with a rotating shaft, and the adaptor can comprise a hollow center. In some embodiments, an output table can be engaged with the adaptor such that the output table rotates with the adaptor. A first dowel pin hole can be disposed between the output table and the adaptor. The first dowel pin hole can have a dowel pin disposed therein, and the first dowel pin can be operable to impart torque from the adaptor to the output table.

In some embodiments, a plug can be disposed within the hollow center of the adaptor. The fit between the plug and the hollow center can be an interference fit that causes the adaptor to expand such that the factor of safety of the adaptor and the output table is greater than or equal to 1.0 during start-up and normal operation of the torque transfer system. In some embodiments, the plug covers a top opening of the hollow center. In some embodiments, the adaptor and the output table form an interference fit.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. While one or more embodiments may be discussed as having certain advantageous features, one or more of such features may also be used with the various embodiments of the invention discussed herein. In similar fashion, while exemplary embodiments may be discussed below as system or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIG. 1 provides a cross-sectional view of a pulverizer, in accordance with an exemplary embodiment of the present invention.

FIG. 2 provides a cross sectional view of a torque transfer system, in accordance with an exemplary embodiment of the present invention.

FIG. 3 provides a perspective view of a plug, in accordance with an exemplary embodiment of the present invention.

FIG. 4 provides top, front, side, and perspective views of a plug, in accordance with an exemplary embodiment of the present invention.

FIG. 5 provides a top view and a side view of a gasket, in accordance with an exemplary embodiment of the present invention.

FIG. 6 provides a top view of a plug and an output table, in accordance with an exemplary embodiment of the present invention.

FIG. 7 provides a flowchart depicting a method of improving a torque transfer system, in accordance with an exemplary embodiment of the present invention.

### DETAILED DESCRIPTION OF THE INVENTION

To facilitate an understanding of the principles and features of the present invention, various illustrative embodiments are explained below. In particular, the invention is described in the context of a torque transfer system and a system or method for improving a pulverizer. Embodiments of the present invention, however, are not so limited, and may be applied to various types of machinery. For example, while many embodiments disclosed herein may be discussed as being applied to pulverizer gearboxes and torque transfer systems, those persons skilled in the art would appreciate that the scope of present invention includes applications in many other systems having gearboxes and/or torque transfer systems—not only pulverizer gearboxes and torque transfer systems.

The components described hereinafter as making up various elements of the invention are intended to be illustrative and not restrictive. Many suitable components or steps that would perform the same or similar functions as the components or steps described herein are intended to be embraced within the scope of the invention. Such other components or steps not described herein can include, but are not limited to, similar components or steps that are developed after development of the invention.

As described above, one problem with conventional torque transfer systems, including those in pulverizers, is that the joint between the adaptor and the output table can fail prematurely. The inventors of the present invention have discovered that the premature failure is often caused by a miscalculated factor of safety that leads engineers to believe the joint is stronger than it actually is. The miscalculations can be due to inaccurate assumptions about the shape of the adaptor, the strength of materials, or how system components will react to applied loads. In several scenarios, the miscalculations can yield an incorrect factor of safety of 1.0 or greater, when the actual factor of safety is below 1.0. In many pulverizers, for example, the calculated factor of safety is above 1.0, but the actual factor of safety is about 0.6, leading to system failure.

In many pulverizers, failure of torque transfer systems can lead to impurities or debris entering the oil systems, which can cause gearbox vibration, elevated bearing temperatures, and failure of the torque transfer system and/or pulverizer. In addition, mechanical failure between the adaptor and the output table can require replacement of these components, and other components damaged by debris. Replacement of these parts can be very expensive.

Therefore, to prevent premature failure of torque transfer systems, embodiments of the present invention can comprise a plug adapted to fit within a hollow center of an adaptor. The plug can be sized and shaped to make the adaptor more rigid, and to cause the adaptor to expand against an output table. In some embodiments, for example, the plug can form an interference fit with the adaptor. The forces applied to the adaptor via the interference fit can cause the adaptor to expand. This expansion can increase the frictional force between the adaptor and the output table, thereby preventing failure of the adaptor, output table, and joint therebetween.

Embodiments of the present invention can also comprise a gasket that can seal the joint between the adaptor and the output table. The gasket can substantially prevent debris from entering the oil system, gearbox, and other undesirable areas during normal use, and during failure, of the torque transfer system.

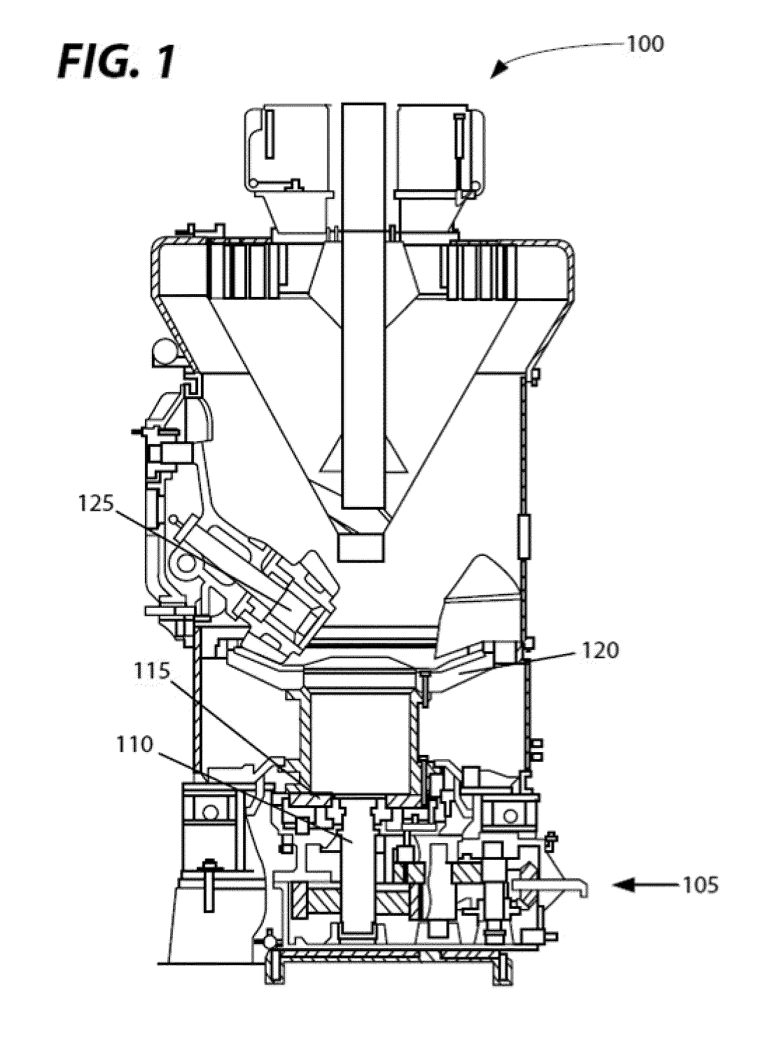

As shown in FIG. 1, embodiments of the present invention comprise a pulverizer 100. The pulverizer 100 can break down materials, such as, for example, ore and other fossil fuels. In some embodiments, the pulverizer 100 can crush coal into small fragments that can be burned in power plants to produce electrical energy.

In some embodiments, a pulverizer 100 can comprise a power input connected to a gearbox 105. The gearbox 105 can rotate a shaft 110, and the torque and rotation from the shaft 110 can be transmitted to an output table 115. The torque and rotation from the output table 115, in turn, can be transferred to a bowl 120. As the bowl 120 rotates, a journal 125, or other crushing device, can break down the material in the bowl. In this manner, torque can be transmitted efficiently from the power input to the bowl 120, and the bowl 120 can rotate at a speed that enables the journal 125 to efficiently break down the material.

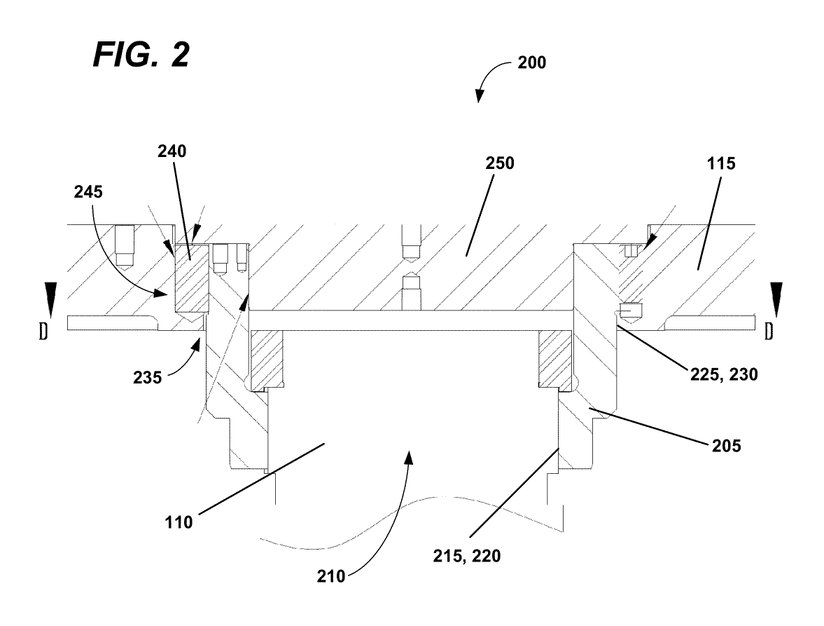

As shown in FIG. 2, embodiments of the present invention can comprise an adaptor 205 for transferring torque and rotation from the shaft 110 to the output table 115. The adaptor 205 can comprise a hollow center 210, and can engage the shaft 110 via splines located on an inner surface 215 of the hollow center 210. The outer surface 220 of the shaft 110 can have complementary splines that engage the splines on the adaptor 205. In this configuration, the shaft 110 can transfer torque to the adaptor 205, and the adaptor 205 can rotate in unison with the shaft 110. In some embodiments, because of the splined configuration, the adaptor 205 can be referred to as a “splined adaptor.” In some embodiments, the adaptor 205 can “float” with respect to the shaft 110 to allow an oil film to develop on thrust bearing pads of the torque transfer system.

In some embodiments, the adaptor 205 can also engage an output table 115. The output table 115, in turn, can receive the output torque from the shaft 110, and transfer the torque to the bowl 120. The output table 115 can be a variety of shapes and sizes. In some embodiments, the output table 115 can comprise an opening located proximate its center.

In some embodiments, the adaptor 205 can engage the opening of the output table 115. More specifically, the outer surface 225 of the adaptor 205 can engage the inner surface 230 of the output table 115 at a joint 235. In some embodiments, the joint 235 can form an interference fit. In other words, the outer surface 225 of the adaptor 205 can be larger than the inner surface 230 of the output table 115. The interference fit can help retain the output table 115 in rotational communication with the adaptor 205. More particularly, the interference fit can help prevent the output table 115 from slipping with respect to the adaptor 205 when torque is applied to the adaptor 205. As used throughout this disclosure, references to the joint 235 can include the adaptor 205 and the output table 115, as the joint 235 can be an area where the adaptor 205 and output table 115 engage.

In some embodiments, the joint 235 can comprise, for example, mechanical fasteners 240 that retain the output table 115 in rotational communication with the adaptor 205. The mechanical fasteners 240 can be many fasteners known in the art, including, but not limited to, splines, pins, bolts, screws, and the like. In some embodiments, the mechanical fasteners 240 can be disposed within a plurality of apertures 245 between the output table 115 and the adaptor 205. The apertures 245 can be, for example, partially within the adaptor 205 and partially within the output table 115. In this configuration, the mechanical fasteners 240 can impart torque from the adaptor 205 to the output table 115.

In some pulverizers 100 and torque transfer systems 200, the adaptor 205 can inadvertently slip with respect to the output table 115. This can occur, for example, during startup of the pulverizer 100, when a maximum amount of torque can be applied to the adaptor 205 and the output table 115. As the adaptor 205 slips, a large amount of stress can be shifted to the mechanical fasteners 240 and apertures 245, causing these components to fail. This failure can cause the mechanical fasteners 240 to act like cams, pushing the inner surface of the output table 115 away from the outer surface of the adaptor 205. This camming action can cause the output table 115, adaptor 205, or both, to fail. More specifically, these components can chip and break proximate the apertures 245 that contain the mechanical fasteners 240. This chipping, breaking, and failure occurs most frequently when the factor of safety of the adaptor 205, output table 115, or joint 235 is less than 1.0.

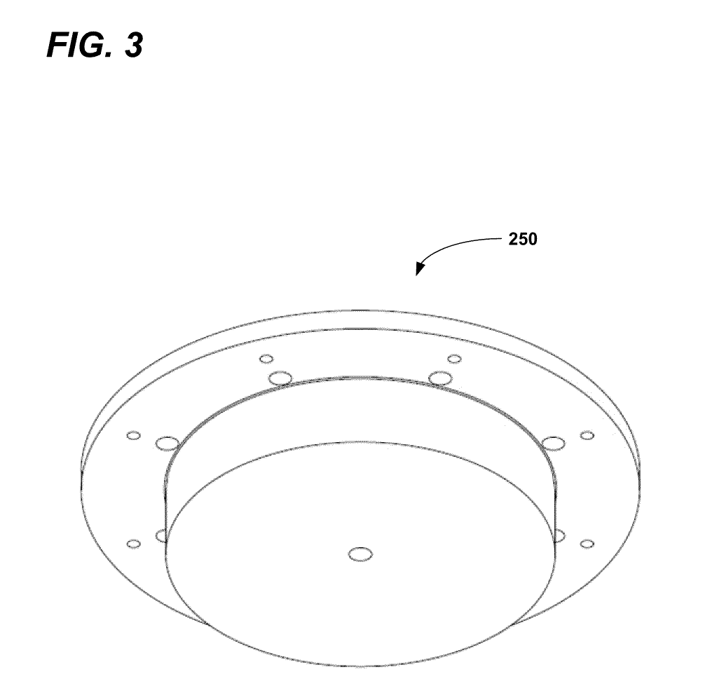

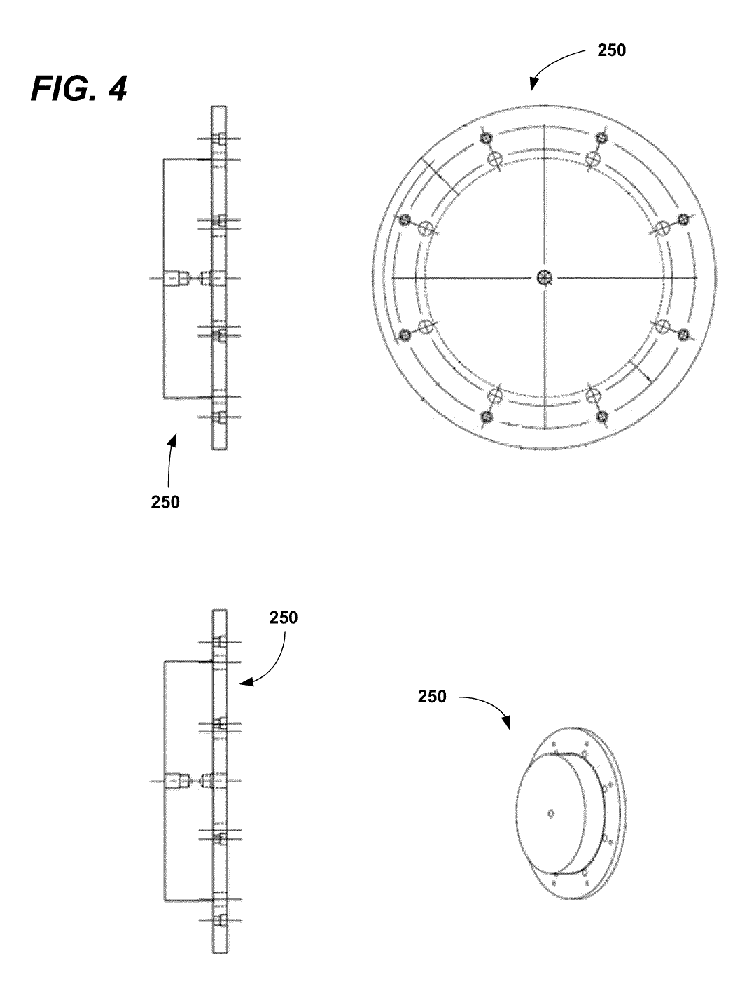

As shown in FIG. 2, embodiments of the present invention can therefore comprise a plug 250 that can prevent failure of the torque transfer system 200. The plug is also shown in FIGS. 3-4. The plug 250 can be at least partially disposed within the hollow center 210 of the adaptor 205, and can form an interference fit with the adaptor 205. The interference fit can exert a radial force on the adaptor 205, causing the adaptor 205 to expand and become more rigid, and increasing the frictional force between the adaptor 205 and the output table 115. The increased friction can prevent slipping between the adaptor 205 and the output table 115, and can therefore prevent failure of the joint 235. More specifically, the plug 250 can enable the factor of safety of the joint 235 to be greater than or equal to 1.0.

In some embodiments, as mentioned above, the increased friction between the adaptor 205 and the output table 115 can prevent slipping of the adaptor 205 relative to the output table 115. Preventing slipping between these components prevents the mechanical fasteners 240 from camming and causing failure of the adaptor 205, output table 115, or both. In some embodiments, the plug 250 can prevent slipping, and thus failure of the system, during all modes of operation, including startup, normal operation, high-torque operation, and shutdown. Accordingly, mechanical failure and damage caused by debris, i.e., gearbox 105 vibration and overheated bearings, can be avoided.

As explained above, embodiments of the present invention can comprise an interference fit between the adaptor 205 and the output table 115. Since pulverizers 100 and torque transfer systems 200 of the present invention can be a variety of sizes, pulverize a variety of materials, and serve a variety of functions, the amount of interference between the adaptor 205 and the output table 115 can vary. The interference can be, for example, about 0.2 inches or less. In some embodiments, the interference can be about 0.01 inches or less. In exemplary embodiments, the interference can vary from between about 0.002 inches to about 0.006 inches. In some embodiments, the inference between the adaptor 205 and the output table 115 influences the size of the plug 250 required to provide a factor of safety at or above 1.0.

In some embodiments, therefore, a design engineer can determine a desired shape and size of a plug 250, or range of shapes and sizes of a plug 250, for a given shape and size of an adaptor 205, and a given interference fit between the adaptor 205 and the output table 115. Accordingly, a design engineer can determine an interference fit, or a range of interference fits, between the plug 250 and the adaptor 205 that will yield a factor of safety for the joint 235 greater than or equal to 1.0. The design engineer can then manufacture a plug 250 and/or an adaptor 205 with the desired dimensions.

The interference between the plug 250 and the adaptor 205 can be a variety of values. The interference can be, for example, about 0.2 inches or less. In some embodiments, the interference can be 0.1 inches or less. In embodiments where the interference fit between the adaptor 205 and the output table 115 varies between about 0.002 inches and about 0.006 inches, for example, the interference fit between the plug 250 and the adaptor 205 can vary between about 0.003 inches and about 0.005 inches to provide a factor of safety at or above 1.0.

In some embodiments, the present invention can comprise a plug 250 that is fitted to an existing pulverizer 100. In some embodiments, therefore, a plug 250 can be fitted to an existing pulverizer 100, for example, as a field retro fit to prevent the adaptor 205 from slipping relative to the output table 115. This makes modification less costly than replacing the adaptor 205 and/or output table 115, and does not require a redesign of original parts. In these embodiments, the dimensions and material properties of the adaptor 205 and the output table 115 can be known. These dimensions and material properties can be used to calculate the necessary dimensions and material properties of a plug 250 that, when installed, enables the factor of safety of the adaptor 205, output table 115, and joint 235 to be greater than or equal to 1.0. In other embodiments, the plug 250 can be fitted to a newly manufactured pulverizer 100. Similarly, in these embodiments, the dimensions and material properties of the adaptor 205 and output table 115 of the new pulverizer 100 can be used to calculate the necessary dimensions and material properties of a plug 250 that enables the factor of safety of the adaptor 205, output table 115, and joint 235 to be greater than or equal to 1.0.

In some embodiments, finite element analysis can be used to determine a size, or a range of sizes, of a plug 250. In some embodiments, for example, the size of the plug 250 can be determined for a given size of an adaptor 205, a given interference fit between the adaptor 205 and an output table 115, and a desired factor of safety. Finite element analysis can be used, for example, to determine the size and material requirements for a plug 250 that will provide a factor of safety of at least 1.0 for a given adaptor 205 having a given interference fit with an output table 115. Finite element analysis can, of course, take into account the forces applied to the adaptor 205, output table 115, and all other components.

In addition to preventing slipping between the adaptor 205 and the output table 115, embodiments of the present invention can substantially prevent debris from entering the hollow center 210 of the adaptor 205. The plug 250, for example, can be a cover for the adaptor 205, preventing debris from falling through the center of the adaptor 205, into the shaft 110, and eventually into the gearbox 105 where debris can cause substantial damage.

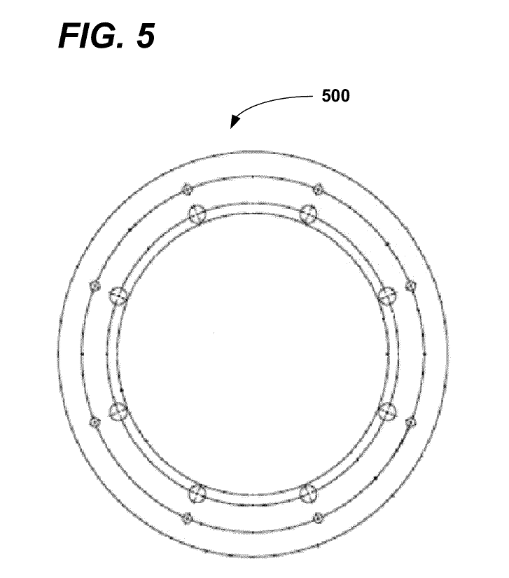

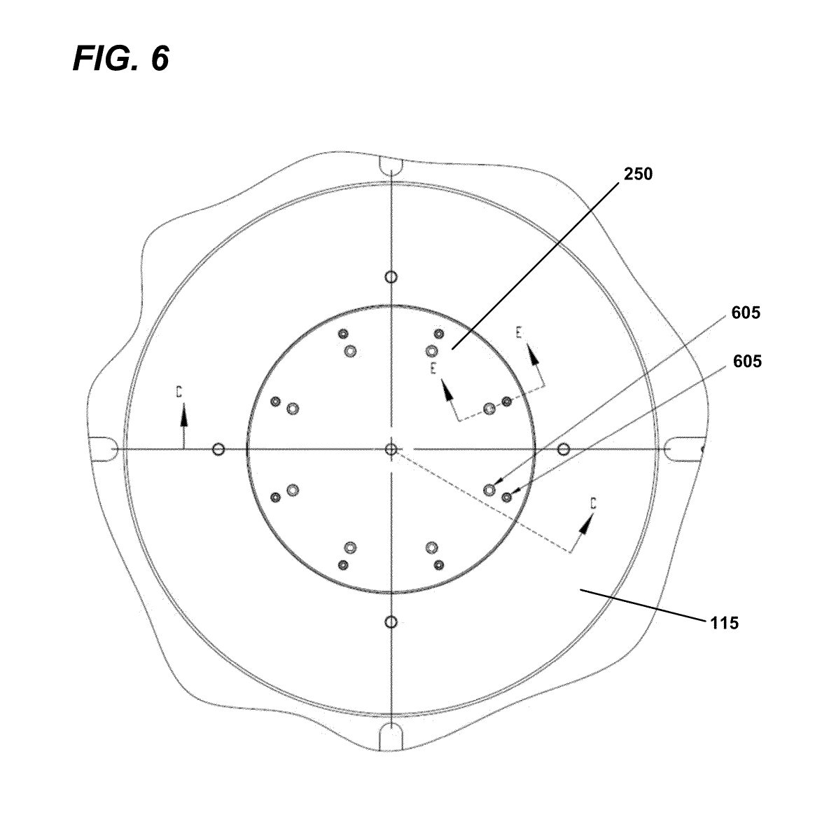

As shown in FIG. 5, embodiments of the present invention can also comprise a gasket 500. The gasket 500 can prevent debris from entering the hollow center 210 of the adaptor 205. The gasket 500 can be disposed, for example, between an upper rim of the plug 250 and the adaptor 205. In some embodiments, the gasket 500 can be thin and disk-shaped with a hollow middle to receive the center corking section of the plug 250. In some embodiments, as shown in FIG. 6, the upper rim of the plug 250 can be mechanically fastened to the adaptor 205 via fasteners 605. The gasket 500 can therefore form a seal between the plug 250 and the adaptor 205, and between the adaptor 205 and the output table 115.

Embodiments of the present invention can comprise a variety of materials. In some embodiments, for example, the plug 250 comprises a material that is sufficiently resilient to exert a force on the adaptor 205 that prevents the adaptor 205 from slipping with respect to the output table 115. The plug 250 can comprise, for example, steel alloy, iron, aluminum, titanium, or magnesium, among other materials. In some embodiments, the plug 250 comprises carbon steel. In some embodiments, the adaptor 205 can comprise steel alloy, such as 4140 steel alloy, for example. In some embodiments, the output table 115 can comprise carbon steel, such as A-36 carbon steel, for example.

In some embodiments, the adaptor 205 is made from a less expensive material than the output table 115 to reduce costs. As described above, for example, the adaptor 205 can comprise steel alloy, and the output table 115 can comprise more expensive carbon steel. Thus, the use of an adaptor 205, instead of a larger output table 115 that connects directly to the shaft 110, can reduce the cost of the torque transfer system.

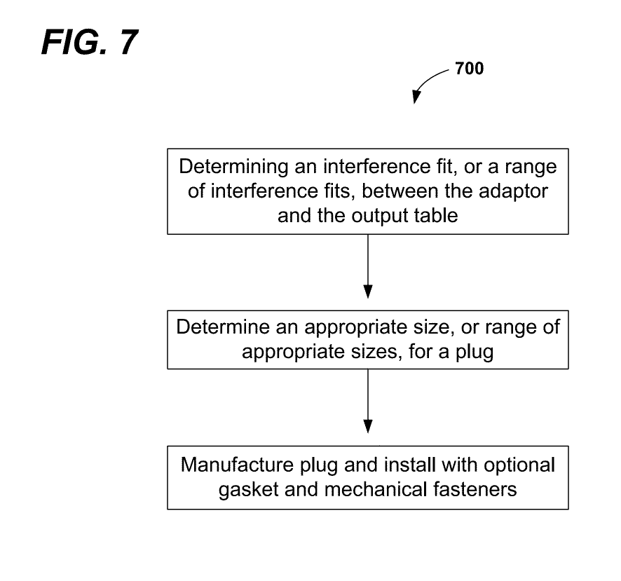

As shown in FIG. 7, embodiments of the present invention can also comprise a method of improving a pulverizer 700. In some embodiments, the present invention can comprise a method of improving a previously manufactured pulverizer 100. In these embodiments, a plug 250 can be fitted to a previously manufactured adaptor 205 with predetermined dimensions, enabling the plug to be a field retro fit. In other embodiments, the present invention can comprise a method of improving a newly manufactured pulverizer 100.

In some embodiments, a method of improving a pulverizer 700 can comprise determining an interference fit, or a range of interference fits, between the adaptor 205 and the output table 115. Then, in some embodiments, the fit between the adaptor 205 and the output table 115 can be used to determine an appropriate size, or range of appropriate sizes, for a plug 250, as well as appropriate materials to manufacture the plug 250 from. In some embodiments, for example, the information can be used to determine a range of interference fits between the plug 250 and the adaptor 205 for which the factor of safety of the adaptor 205 and the output table 115 is greater than or equal to 1.0 during start-up, normal operation, high-torque operation, shutdown, and all other modes of operation of the pulverizer 100. In some embodiments, finite element analysis can be used to determine the range of interference fits, as discussed above.

After a size, or a range of sizes, for a plug 250 is determined, the plug 250 can be manufactured and installed. To install the plug 250, it can be placed in the hollow center 210 of the adaptor 205. Since the hollow center 210 and the plug 250 can form an interference fit, the plug 250 can be cooled so that it shrinks to fit inside the hollow center 210. In some embodiments, the adaptor 205 can also be heated so that it expands to receive the plug 250. Moreover, a gasket 500 can be installed between the plug 250 and the adaptor 205. As described above, the gasket 500 can prevent debris from entering the hollow center 210 of the adaptor 205.

In addition, as also discussed above, mechanical fasteners 240 can be installed in one or more apertures 245 disposed between the output table 115 and the adaptor 205. The fasteners 240 can impart torque from the adaptor 205 to the output table 115. To prevent the adaptor 205, output table 115, or mechanical fasteners 240 from failing, the forces applied to the aperture, adaptor 205, output table 115, and/or mechanical fasteners 240 can be taken into account when determining the appropriate size of the plug 250. In some embodiments, these forces are taken into account in finite element analysis.

In some embodiments, the effect of the plug 250 can be to increase the factor of safety of the joint 235, adaptor 205, output table 115, apertures 245, and/or mechanical fasteners 240. In this manner, the plug 250 can prevent the pulverizer 100 from failing prematurely. Some pulverizers 100 without a plug 250, for example, have a joint 235, adaptor 205, output table 115, aperture 245, and/or mechanical fastener 240 with a factor of safety below 1.0 during start-up, normal operation, shutdown, and other modes of operation of the pulverizer 100. Installation of a plug 250 in accordance with embodiments of the present invention, however, can enable the factor of safety of these joints 235 and components to be 1.0 or greater during these modes of operation.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A torque transfer system comprising:
a shaft coupled to a gearbox, the gearbox imparting torque to the shaft;
an adaptor engaged with the shaft, the adaptor comprising a hollow center;
an output table engaged with the adaptor; and
a plug, wherein at least a portion of the plug is disposed within the hollow center of the adaptor.

2. The system of claim 1, wherein the plug is sized and shaped to enable the factor of safety of the adaptor and the output table to be greater than or equal to 1.0 during start-up and normal operation of the system.

3. The system of claim 1, wherein the plug and the adaptor form an interference fit.

4. The system of claim 1, wherein the output table and the adaptor form an interference fit.

5. The system of claim 1 further comprising a plurality of apertures disposed between the output table and the adaptor, the apertures having pins disposed therein, the pins operable to impart torque from the adaptor to the output table.

6. The system of claim 1, wherein the plug substantially prevents debris from entering the hollow center of the adaptor.

7. The system of claim 1, wherein the plug comprises a lower corking section and an upper rim section that is mechanically fastened to the adaptor, and wherein a gasket is disposed between the upper rim section and the adaptor, the gasket operable to substantially prevent debris from entering the hollow center of the adaptor.

8. The system of claim 7, wherein the upper rim section has a cross-sectional area greater than a corresponding cross-sectional area of the adapter, such that the plug completely covers a top opening of the hollow center of the adapter.

9. A method of improving a torque transfer system, the torque transfer system comprising an output table, an adapter engaged with the output table, the adapter comprising a hollow center and operable to transfer torque from a shaft to the output table, the method comprising:
determining a first range of interference fits between the output table and the adaptor;
determining, based at least in part on the first range of interference fits between the output table and the adaptor, a second range of interference fits between the adaptor and a plug to be installed in the hollow center of the adaptor, such that the factor of safety of the adaptor and the output table is greater than or equal to 1.0 during start-up and normal operation of the pulverizer; and
installing the plug in the hollow center of the adaptor, such that the plug and the adaptor form an interference fit within the second range of interference fits.

10. The method of claim 9, wherein installing the plug comprises cooling the plug and inserting the cooled plug into the hollow center of the adaptor.

11. The method of claim 9, further comprising installing a pin in an aperture disposed between the output table and the adaptor, the pin operable to impart torque from the adaptor to the output table.

12. The method of claim 11, wherein at least one of a force applied to the aperture and a force applied to the pin is used to determine the second range of interference fits.

13. The method of claim 9, wherein determining the second range of interference fits comprises performing finite element analysis.

14. The method of claim 9, further comprising substantially preventing debris from entering the hollow center of the adaptor by covering a top opening of the hollow center with the plug.

15. The method of claim 9, wherein installing the plug comprises installing a gasket between at least a portion of the plug and at least a portion of the adaptor.

16. A system for preventing premature failure of a torque transfer system, the system comprising:
an adaptor engaged with a rotating shaft, the adaptor comprising a hollow center;
an output table engaged with the adaptor such that the output table rotates with the adaptor;
a first dowel pin hole disposed between the output table and the adaptor, the first dowel pin hole having a dowel pin disposed therein, the first dowel pin operable to impart torque from the adaptor to the output table; and
a plug disposed within the hollow center of the adaptor;
wherein the fit between the plug and the hollow center is an interference fit that causes the adaptor to expand such that the factor of safety of the adaptor and the output table is greater than or equal to 1.0 during start-up and normal operation of the torque transfer system.

17. The system of claim 16, wherein the plug covers a top opening of the hollow center.

18. The system of claim 16, wherein the adaptor and the output table form an interference fit.

19. The system of claim 16, wherein the adaptor and the plug form an interference fit.

20. The system of claim 16, wherein the plug comprises a lower corking section and an upper rim section that is mechanically fastened to the adaptor, and wherein a gasket is disposed between the upper rim section and the adaptor, the gasket operable to substantially prevent debris from entering the hollow center of the adaptor.
